(19) United States
(12) Patent Application Publication
(10) Pub. No.: US 2023/0374687 A1
(43) Pub. Date: Nov. 23, 2023

(54) LITHOGRAPHICALLY PATTERNED POLYPYRROLE MULTILAYER MICROSTRUCTURES VIA SIDEWALL-CONTROLLED ELECTROPOLYMERIZATION

(71) Applicant: The Trustees of the University of Pennsylvania, Philadelphia, PA (US)

(72) Inventors: Mark George Allen, Philadelphia, PA (US); Michael Joseph Synodis, San Francisco, CA (US); Jun Beom Pyo, Philadelphia, PA (US)

(21) Appl. No.: 18/024,737

(22) PCT Filed: Sep. 10, 2021
(86) PCT No.: PCT/US2021/049797

§ 371 Date: Mar. 3, 2023

Related U.S. Application Data
(60) Provisional application No. 63/076,726, filed on Sep. 10, 2020.

(51) Int. Cl. C25D 1/00; B33Y 10/00

(52) U.S. Cl. CPC C25D 1/003; B33Y 10/00

(57) ABSTRACT

Methods and systems for producing metal/polymer multilayer microstructures. In some examples, a method includes method for fabricating a multilayer microstructure using sequential multilayer deposition. This method includes deposition of an active metal containing desired physical, mechanical, and/or electrical properties, followed by the deposition of a protective layer of an inert metal. Subsequently, a polymer layer is deposited in which the deposition bath chemistry and conditions are optimized to control the growth direction and rate of the polymerization and thus the morphology of the layer. This is defined as the morphological polymer layer. A film of the same polymer with different polymerization conditions is then deposited such that a proper interface for subsequent metal deposition is created; this is the interfacial polymer layer. Lastly, the interfacial polymer layer is activated by deposition of a thin pure metal on the surface, creating an optimal substrate for the next active metal layer.

### PRIORITY CLAIM

This application claims the benefit of U.S. Provisional Patent Application Ser. No. 63/076,726, filed Sep. 10, 2020, the disclosure of which is incorporated herein by reference in its entirety.

### TECHNICAL FIELD

The subject matter described herein relates generally to fabricating multilayer microstructures. More particularly, the subject matter described herein relates to methods and systems for fabricating metal/polymer multilayer composites containing polypyrrole.

### BACKGROUND

Due to their unique properties, conductive polymers can act as environmentally friendly, biocompatible materials for use in sensing, biomedical, and energy storage/conversion applications. In particular, composite materials comprised of layers of metal and conductive polymer can display anisotropic properties, such as electric conductivity, that make them useful as materials for magnetics or other microelectronic devices; however, incorporating the deposition of conductive polymers into scalable and manufacturable fabrication processes can be challenging, as the mechanisms for electropolymerization are complex and other forms of physical deposition are either expensive or cannot achieve layers at the required length scale.

An additive approach to fabricate metal/polymer multilayer structures was previously presented, using soft magnetic alloys as the metal and polypyrrole as the polymer. In order to make this additive fabrication scheme manufacturable, many multiples of alternating metal/polymer pairs must be deposited within specifically defined lithographic molds to achieve composites with both useful overall volumes and geometries.

### SUMMARY

This document describes methods and systems for producing metal/polymer multilayer microstructures. In some examples, a method includes method for fabricating a multilayer microstructure using sequential multilayer deposition. This method includes deposition of an active metal containing desired physical, mechanical, and/or electrical properties, followed by the deposition of a protective layer of an inert metal. Subsequently, a polymer layer is deposited in which the deposition bath chemistry and conditions are optimized to control the growth direction and rate of the polymerization and thus the morphology of the layer. This is defined as the morphological polymer layer. A film of the same polymer with different polymerization conditions is then deposited such that a proper interface for subsequent metal deposition is created; this is the interfacial polymer layer. Lastly, the interfacial polymer layer is activated by deposition of a thin pure metal on the surface, creating an optimal substrate for the next active metal layer.

### BRIEF DESCRIPTION OF THE DRAWINGS

FIGS. 1A and 1B show schematics of a multilayer composite fabrication process based on additive, synthetic insulation and a schematic of a laminated structure, including individual layer thicknesses of metal and polymer (tₘ and tₚ). The total thickness of the laminated structure is T.

FIG. 2 illustrates a mechanism for the anodic polymerization of pyrrole.

FIG. 3 shows top-down SEM images of PPySal plated through a positive photoresist pattern of concentric rings. Inset shows polymer overgrowth at the sidewalls of the pattern, resulting in larger thicknesses at the edge as compared to the center.

FIGS. 4A and 4B show pattern wall to pattern center thickness ratios (α) as a function of monomer concentration, parameterized by the type of anion in the polymerization bath. Anion concentration was kept constant at 100 mM. FIG. 4B shows insets a) and b) that illustrate example thickness profiles of 500-micron-wide patterned films using SAL and DBS baths, respectively, with 25 mM monomer concentration. The horizontal line at α=1 on the left plot indicates the minimum (and best) possible value of α.

FIGS. 5A and 5B show voltage deposition profiles for PPy electropolymerization (FIG. 5A) and Ni strike activation with both salicylate and DBS electrolytes (FIG. 5B).

FIGS. 6A-6C show top-down optical images of a sample toroidal patterned area after a) NiFe on PPySal, b) NiFe on PPyDBS and c) NiFe on Ni on PPySal.

FIGS. 7A-7C show top down, optical images of multilayer structures after metal deposition. FIG. 7A is Ni strike on NiFe-PPyDBS multilayer, FIG. 7B is Ni strike on NiFe-PPySal multilayer, and FIG. 7C is NiFe on Ni Strike on PPySal-NiFe multilayer.

FIG. 8 shows deposition profiles for all layers in the optimized five-bath electrodeposition scheme. The potential was measured between the working and counter electrodes (W/C) for each electrodeposition/electropolymerization step.

FIGS. 9A-9D show optical and SEM images of laminated structures generated by the optimized five-bath deposition scheme. a) Top-down view of test mask after multilayer plating b) Optical microscope image of the multi-anion PPy insulating layer c) Optical microscope image of the top layer of NiFe after two sets of the five baths were completed and d) A FIB/SEM cross sectional image highlighting the distinct multilayer laminated sets.

FIG. 10A shows a magnified FIB/SEM cross sectional image of a two-set laminated stack using the optimized five-bath multilayer electrodeposition process. The layer corresponding to each bath in the set is labeled. FIG. 10B shows an SEM cross sectional image at the edge of a patterned lamination (where the photoresist wall once was), indicating minimized lateral growth of the polymer layers and increased multilayer uniformity.

FIG. 11A shows sample profilometry data for a 5 set patterned multilayer laminated structure, where each set consists of NiFe—Au-PPyDBS-PPySal-Ni constructs. FIG. 11B shows a schematic of the measured patterned multilayer structure. The total metal and polymer layer thicknesses were optimized (via deposition conditions) to be one micron each, resulting in an approximately 11-micron total laminated structure. Note that peaks that would indicate lateral polymer growth during deposition are absent in the profilometry data.

### DETAILED DESCRIPTION

One issue that arises when growing multilayers in lithographic molds is the need to suppress lateral growth of the polypyrrole layers during electrodeposition, which is typically much faster than vertical growth and results in non-uniform layer geometry and growth of the polymer on and above the patterned molds. In this work, we achieve suppression of lateral polypyrrole growth by control of electropolymerization bath counter-anions and passivation of underlying metal layers during deposition. The lateral-to-vertical growth rate uniformity ratio is reduced by a factor of 6 (to approximately unity) through polymerization parameter optimization and continuous 5-bath plating process. The reduction in lateral growth rate enhances the scalability of multilayer structures that are fabricated using this additive electrodeposition-based approach and provides a manufacturable route to metal/polymer composites with tunable volume and geometry without sacrificing microstructure and properties.

### Introduction

Conductive polymers, as a class of materials, can display a wide range of mechanical, electrical, and thermal properties, which makes them uniquely suited for incorporation into microelectromechanical systems (MEMS). They can act both as structural or active layers in supercapacitors or batteries [1-4], sensors [5-7], actuators [8-10], biocompatible devices [11-13] and magnetics [14-16]. Due to their intermediate electrical conductivities in particular, conductive polymers have been investigated as interlamination materials in multilayer composites, where an overall structure consists of alternating layers of metal and polymer [17]. Such composites have been shown to display anisotropic conductivities, where current flow through the structure is drastically different in the vertical and lateral directions. Such directed electrical properites are especially useful in magnetics, and could be an enabler of on chip miniaturized magnetic devices.

MEMS-scale multilayer structures are typically fabricated by deposition-based methods, since traditional lamination approaches based on milling, cutting, and stacking processes exhibit technical difficulties in achieving layers with desired microscale thicknesses. Sequential, “top-down” physical vapor deposition of metal and polymeric material can create structures with controlled, nanoscale individual layer thicknesses [18]; however, its relatively poor scalability (due to high built-in stress) and high cost (due to non-selective, vacuum-based deposition processes) are not compatible with high volume production. As an alternative, electrodeposition-based MEMS lamination processes provide both layer thickness control as well as scaling to maintain or improve overall material volume and, if applicable, performance outputs. While direct electrodeposition of metallic and insulating interlayer materials (which would be analogous to sequential physical vapor deposition) is not feasible due to the difficulty of electrodepositing a metal (or metal alloy) directly on a non-conducting material, development of additive approaches based on direct, non-vacuum based deposition of a semi-insulating interlamination material (like a conductive polymer) would make commercialization of these technologies more viable.

A major challenge to incorporating conductive polymers into composite materials with micron scale feature sizes is depositing the polymer into patterned molds. Electro-polymerization (analogous to electroplating) mechanisms for conductive polymers are complex, and the polymerization reactions often result in growth rates that are higher in the lateral direction due to the chain structure of the polymer. High polymeric lateral growth coats the surface of lithographic molds (often over-depositing on the edges of the patterns), resulting in structures with non-uniform geometries, layer overlap, and potential loss of desired material properties.

In previous work, proof of concept magnetic laminations were fabricated using an additive, electrodeposition-based approach whereby a conductive polymer (polypyrrole, or PPy) was utilized as an insulating material within magnetic layers comprised of a nickel-iron alloy (Ni80Fe20, or permalloy) [17]. The electrical performance of these PPy-NiFe laminations was excellent, as the ratio of electrical conductivity in the lateral to vertical direction was over 106; However, the scalability of these structures was limited, as the lateral growth of PPy during electropolymerization resulted in large anisotropy in lamination thicknesses at the edges of the patterned multilayers as compared to the center [17]. Thus, optimization of the PPy electropolymerization process is necessary to achieve a manufacturable route that avoids the use of larger molds for layer deposition (which are harder to fabricate) as well as eliminates wasted material.

In this study, the mechanism for PPy electropolymerization is analyzed to influence the polymerization bath compositions, layer deposition order, and deposition conditions that can be utilized in a scalable additive fabrication approach for micro-scale multilayer composite materials. The resulting structures were physically characterized to ensure proper layer anisotropy and analyzed for potential use in future commercial applications.

### Polypyrrole Lamination Fabrication

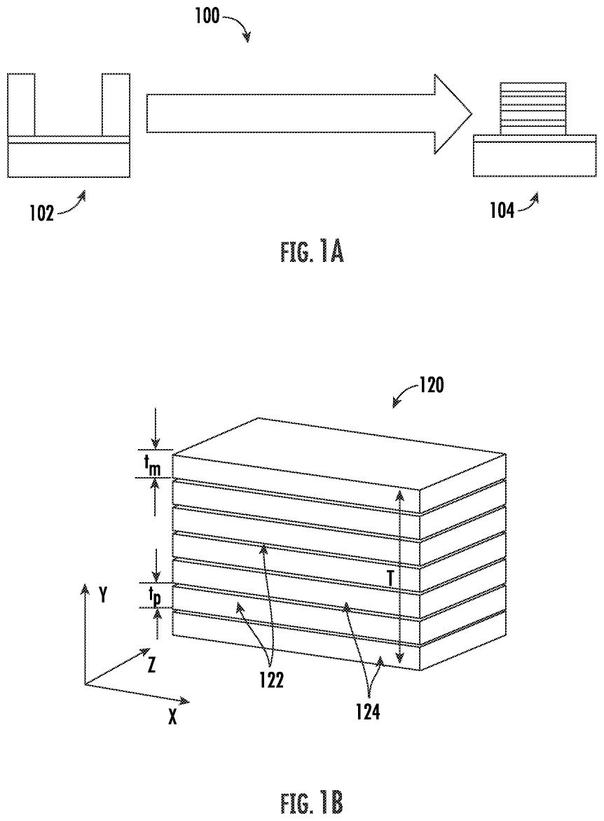

FIGS. 1A and 1B show schematics of the previously identified fabrication approach for multilayer magnetic laminations [17]. The details of the process are described in [17] as well. FIG. 1A shows an additive fabrication method 100 by illustrating a seed layer and mold preparation 102 and direct synthesis of metal/polymer composite structure 104. FIG. 1B shows a laminated structure 120 based on alternating layers of electrodeposited metal 124 and polymer 122.

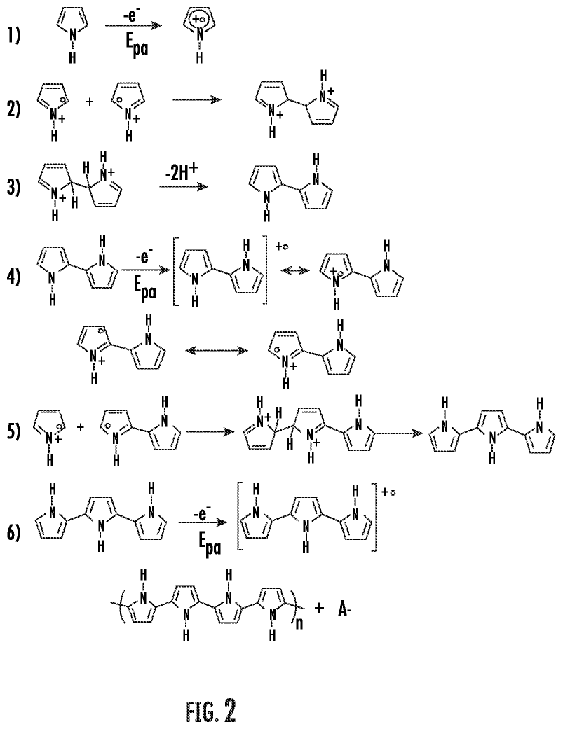

The electropolymerization of the polymer insulating layer is completed in a deposition bath that consists of pyrrole monomer and a supporting electrolyte. The process occurs anodically and is initiated by the oxidation of a monomer molecule into a radical cation at the surface of the working electrode [19]. These monomer radicals can then react to form dimers that subsequently undergo dehydrogenation to form a stable species, as shown in FIG. 2. During this process, anions in the supporting electrolyte migrate to the dimer site to maintain local charge neutrality and are thus incorporated into the chains as polymerization continues. During the initiation process, the supplied current must be high enough such that dimers and trimers can be formed at the surface of the working electrode before the radical monomers diffuse away or react with the electrolyte to form soluble products. Chains with two or more pyrrole monomer links are more stable after oxidation due to their ability to delocalize the radical across multiple rings. Termination of the polymerization reaction occurs when the current source is removed, and the further oxidation of monomer radicals ends [19].

It was found that the lateral electrical conductivity of the electropolymerized PPy was larger than its conductivity in the vertical direction [17], and thus it is hypothesized that there is an enhanced driving force for growth in the lateral direction, resulting in an increased thickness of electropolymerized polymer at the sidewalls of a lithographically patterned mold as opposed to the center. As the monomer is polymerized, it grows outward to the edge of the conductive substrate and the insulating photoresist, at which point it grows laterally up the surface of the wall as further monomers are attached to the previous chain. The ratio of the thickness (in microns) of a deposited polymer layer at the edge of a pattern (t_{w}) to the thickness at the center (t_{c}) is defined as α, as shown in Equation 1.

$$α = \frac{{t}_{w}}{{t}_{c}} \qquad ( 1 )$$

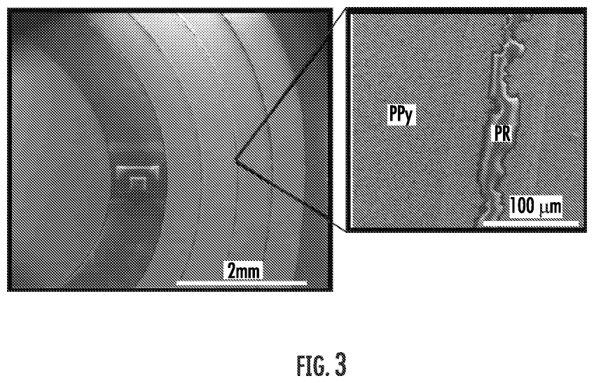

A typical α value measured for the standard PPy deposits discussed in previous work approximately six, which leads to the type of over-plating shown in FIG. 3 [12].

In FIG. 3, the deposition of polymer is demonstrated to be uniform across the area of the substrate, meaning that the polymer thickness was equal across the entire footprint; however, the uniformity in the vertical direction within each individual pattern was poor.

In FIG. 3, the large overgrowth at the edge of the patterns indicate the increased thickness of polymer at the photoresist wall interface due to lateral chain growth. In typical metal electrodeposition through a photoresist mold, the material growth is contained in the vertical direction and thickness uniformity (α=1) is observed. In general, high values of α indicate preferred growth of a material in the lateral direction during electrodeposition/polymerization (which leads to large peaks at the sides of patterns due to growth up the side of the photoresist wall), values close to two indicate isotropic growth (or equal rates in the vertical and lateral directions), and values approaching one indicate preferred growth in the vertical direction (and thus no growth up the side of the patterned walls). The key metric for evaluating a polymerization solution and deposition condition is whether or not the α value is close to one, such that the thickness within a given molded pattern is the same at any lateral x or y position within that area. This metric predicts the scalability and ultimate manufacturability of a given composite material set.

### PPy Electropolymerization Optimization

### Supporting Anion Optimization

In order to improve the electropolymerization performance of polypyrrole interlamination layers, the mechanism of polymerization was considered. This analysis led to the formation of three main hypotheses: 1) The monomer concentration in the polymerization bath affects the extent of the anisotropy in the growth rates, 2) The type of anion used in the supporting electrolyte plays a role in the deposition type and ultimate properties of the resulting films [20, 21], and 3) The current density used for deposition is crucial in controlling the reaction—there must be sufficient current supplied to initiate dimer formation and radicalization, but not so much that the difference in lateral growth rate due to large conductivity anisotropy of the deposited layers of PPy is enhanced. To test these hypotheses, the following experimental setup is utilized: a test photoresist mold using the toroidal patterns shown in FIG. 3 is generated by spin casting AZ4620 positive resist (MicroChem) on a glass substrate coated with a seed layer of sputtered Ti/Au (50 nm/100 nm). After developing the patterns into the photoresist, pyrrole is electropolymerized through the mold using various bath compositions and current conditions, and the resulting film is characterized via profilometry for thickness (and □ calculation) and optical and SEM microscopy for structural uniformity. Additionally, deposition voltage profiles and compatibility with NiFe plating and Ni surface activation are measured.

The anions used in this study were salicylate (as sodium salicylate or NaSal), dodecylbenzensulfonate (as NaDBS), and saccharin (as NaSac). These supporting electrolyte salts are some of the most commonly used in polypyrrole manufacturing [22-26]. Polymerization baths were prepared by vacuum distilling the pyrrole monomer and adding the desired concentration to a solution with freshly dissolved supporting electrolyte. A parameter sweep across a range of monomer concentrations as well as supporting anion type and concentration was conducted to identify both the anion and bath conditions that lead to optimal growth rates.

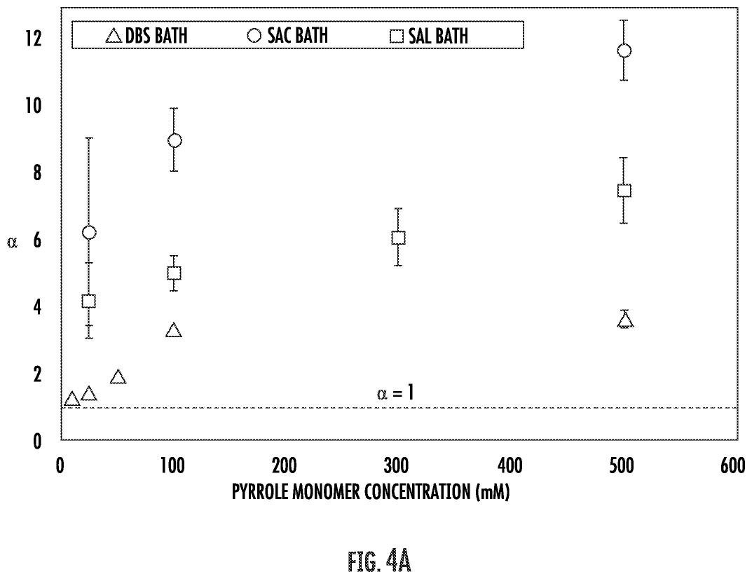

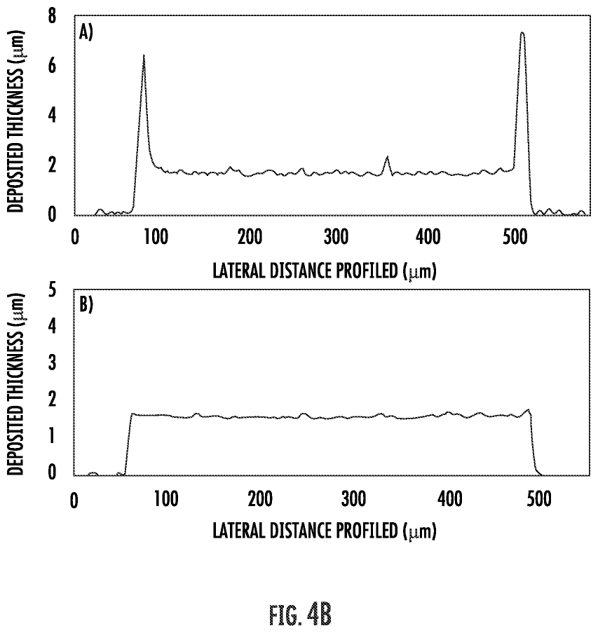

The concentration of the pyrrole monomer was adjusted for each bath while maintaining the anion concentration constant, such that the effects of the type of anion as well as monomer amount could be analyzed. The deposition profilometry results are shown in FIGS. 4A and 4B, where there is a clear trend indicating that reducing the ratio of the monomer concentration to the anion concentration results in reducing the α value for that particular bath combination. Additionally, the DBS anion clearly outperforms the other two, as the α values for the DBS bath are all statistically significantly lower at any monomer concentration than those of the other two anions.

At the lowest monomer concentrations (10 mM and 25 mM), the DBS bath enables the reduction of α to approximately 1.2, which is very close to the completely flat condition of α=1. This is highlighted by the insets in FIG. 4B, where image a) shows large peaks in the film profile at the pattern edge due to lateral growth of PPySAL and a high α, whereas image b) shows the flat profile with low α achieved using PPyDBS. A possible mechanism for the reduction of α using DBS (compared to the salicylate and saccharin anions) is that the long carbon chain attached to the end of the benzene ring provides steric hindrance to lateral growth of the monomer chains [27]. NaDBS, as a surfactant, forms energetically favorable micelle-like configurations around the monomer molecules as they are diffusing to the surface of the working electrode. Upon oxidative polymerization, these long chains provide a barrier to growth in the lateral direction and thus greatly reduce the anisotropy in the thickness towards the edge of a patterned mold in comparison to the center. This effect, combined with a reduction in the overall monomer concentration in the polymerization bath, can enhance just the vertical growth of the PPy films. The salicylate and saccharin ions, conversely, cannot form structures that provide steric hindrance, and thus demonstrate □ values in the four to six range even at low monomer concentrations.

### Multilayer Fabrication Optimization

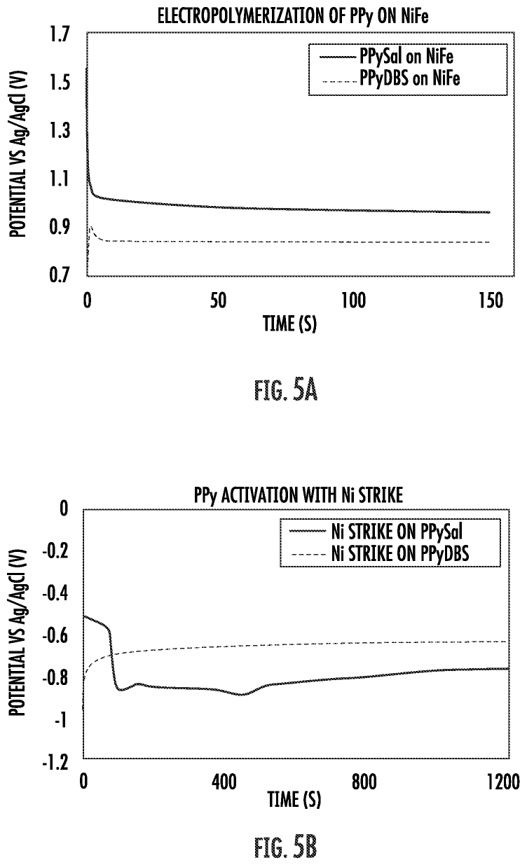

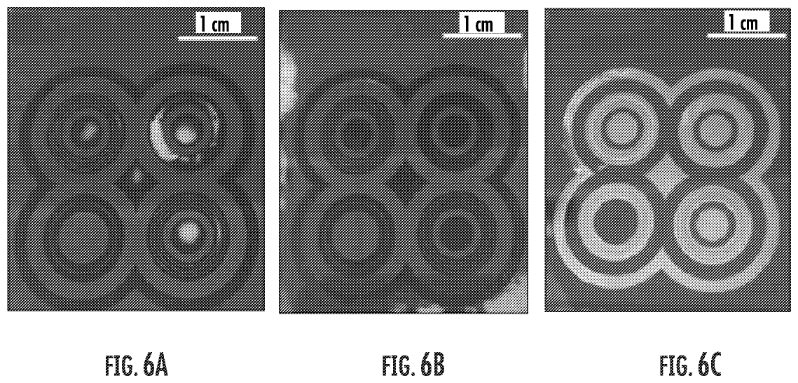

In order to determine the efficacy of using the various anion-doped polymers in a multilayer construct, the electrodeposition voltage profiles were measured during various steps in the overall fabrication process, as shown in FIGS. 5A-5B. The deposition characteristics with the DBS-based bath were first compared to deposition with the Sal bath (FIG. 6A). At a typical current density of 2.5 mAcm-2, the deposition potential of PPyDBS and PPySal are stabilized at approximately +1 and +0.87 V, respectively relative to Ag/AgCl; however a large activation peak can be seen with the DBS anion, which is hypothesized to be due to underlying corrosion of the NiFe substrate layer.

The salicylate head group is able to form a complex with active metals that prevents their complete oxidation during the initiation of the anodic polymerization process. This has been demonstrated in literature by CV experiments performed with salicylate anions on active metals such as zinc and copper [28]. It is hypothesized that this complexing effect reduces the initial voltage peak during polymerization and slightly passivates the underlying metal surface until complete coverage of the surface with polymer is achieved.

Surface activation of the polypyrrole layer with a low potential Ni strike was also tested with polypyrrole films deposited with both Sal and DBS anions (FIG. 5B). At the initial stage of deposition, the Ni reduction onto the PPyDBS surface occurs at a significantly lower potential compared to the deposition on the PPySal, but the Ni deposition potential on the PPyDBS gradually increases beyond the PPySal potential. The initial low Ni deposition potential of PPyDBS corresponds to the potential measured on a bare NiFe surface (−0.543 V, 0.1 s after the deposition began). Thus, it is hypothesized that the Ni deposition reaction occurs not only on the PPyDBS, but also from the surface of the previously deposited NiFe layer. A potential cause of this could be that the size of the DBS anions that are incorporated into the chains during polymerization increase the porosity of the films, resulting in easier migration of nickel ions to the more conductive NiFe surface below.

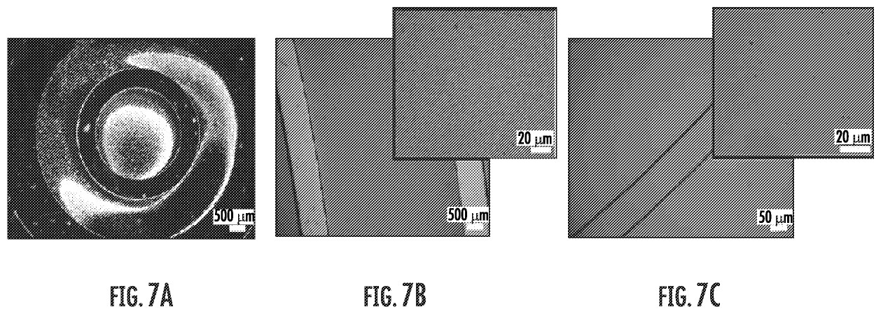

During deposition of Ni on the PPySal surface, as the thickness of the Ni film increases the resistance of the substrate decreases (due to Ni conductivity being much larger than PPy), and the deposition potential decreases as well. The smooth deposition profile indicates that there are no areas of local nickel deposition directly on the NiFe surface, and the lower deposition potential of PPySal on NiFe in FIG. 5A indicates the passivation of the NiFe surface. The result of these two phenomena, as shown in the optical images contained FIGS. 6 and 7, is that successful multilayer laminations are only possible with a nickel strike activation on the surface of a PPySal polymeric layer.

The images in FIGS. 6A-6C demonstrate that permalloy deposition is not successful through direct deposition on PPyDBS or PPySal, but rather only through depositing PPySal, activating with Ni, and then depositing the NiFe (FIG. 6C). In FIGS. 7A-7C, optical images show the uniformity of metal deposits on top of the polymer surfaces. FIG. 7A shows an image of a nickel strike layer on a PPyDBS surface. As mentioned previously, only islands of Ni form through the polymer layer, as the porosity of the DBS films increases the ability of the Ni to deposit directly on the underlying NiFe layer. FIGS. 7B and 7C show uniform Ni and NiFe deposition on PPySal, thus confirming that the complexing effect of the Sal anion as well as the denser resulting polymer films facilitates multilayer lamination fabrication. Note that in FIG. 7C it is also clear that there is more deposition at the edges of the pattern, confirming the high a characteristic of the PPySal deposition.

Given the characteristics of all tested anions, it is unlikely that a bath composition and polymerization condition can be found that can result in both a low α value and essential multilayer properties for just a pure polymer film. Thus, experiments were performed with a variety of mixed Sal and DBS bath conditions, with the results summarized in Table 1.

TABLE 1
Summary of mixed DBS and Sal deposition experiments

| | DBS | SAL | Py | Current | α | |
|---|---|---|---|---|---|---|
| | Conc | Conc | Conc | Density | Aver- | α |
| Bath Type | (M) | (M) | (M) | (mAcm⁻²) | age | Stdev |
| DBS only | 0.1 | 0 | 0.01 | 0.29 | 1.08 | 0.04 |
| SAL, low J | 0 | 0.1 | 0.3 | 0.25 | 2.73 | 0.90 |
| SAL, med J | 0 | 0.1 | 0.3 | 1 | 4.67 | 0.91 |
| SAL, high J | 0 | 0.1 | 0.3 | 2.5 | 5.15 | 2.18 |
| SAL pulse low | 0 | 0.1 | 0.3 | 2.5 (0.1 s on, | 2.31 | 1.05 |
| | | | | 1 s off) | | |
| SAL pulse high | 0 | 0.1 | 0.3 | 2.5 (0.1 s on, | 1.83 | 0.46 |
| | | | | 10 s off) | | |
| Mixed DBS SAL | 0.3 | 0.3 | 0.3 | | 1.36 | 0.23 |
| DBS + SAL Strike | 0.1 | 0.1 | (0.01, 0.3) | 0.25, 2.5 | 1.31 | 0.09 |
| DBS, SAL, Ni, | 0.1 | 0.3 | (0.01, 0.3) | 0.25, 2.5, | 1.42 | 0.29 |
| NiFe | | | | 0.5, 10 | | |

A few inferences can be made from the data in Table 1. The first is that changing the current density of pure PPySal deposition while keeping the monomer concentration high is insufficient to minimize the lateral growth rate. However, utilizing pulse deposition at the same monomer concentration and current density resulted in an □ value of 1.83. Additionally, using a combination layer of PPyDBS first with a thin PPySal strike on top further decreased □ to between 1.3 and 1.4. While using a bath with both DBS and Sal ions in the solution resulted in a similar □ value, Ni strike activation on the resulting polymer surface failed, indicating that it is necessary to have a corrosion free substrate as well as a pure PPySal surface for the activation towards multilayer deposition.

### Optimized Fabrication Results

Given the results shown in Table 1, a final multilayer deposition experimental setup with a five step plating process was designed, taking into account all of the necessary conditions needed to achieve good interfaces between the magnetic and insulating polymer layers as well as the uniformity (both throughout the patterned areas as well as in the vertical direction) to achieve scaling capabilities. The process steps for each set of layers in the composite stack are listed in Table 2.

TABLE 2
Process summary for batch fabrication of multilayer
polymer/metal composites

| Process | Material | | Deposition |
|---|---|---|---|
| Step | Deposited | Deposition Bath | Conditions |
| 1 | NiFe | Nickel sulfate, Nickel | Cathodic, |
| | | chloride, Boric acid, | 10 mAcm⁻² |
| | | Saccharin | |
| 2 | Au | Transene Sulfite Gold | Cathodic, |
| | | Commercial Solution | 2 mAcm⁻², |
| | | | 60° C. |
| 3 | PPyDBS | Pyrrole monomer, Sodium | Anodic, |
| | | dodecylbenzene sulfonate | 0.25 mAcm⁻² |
| 4 | PPySAL | Pyrrole monomer, Sodium | Anodic, |
| | | salicylate | 2.5 mAcm⁻² |
| | | | pulses |
| 5 | Ni | Nickel chloride anhydrons, | Cathodic, |
| | | Boric acid, saccharin | 0.5 mAcm⁻², |
| | | | 46-50° C. |

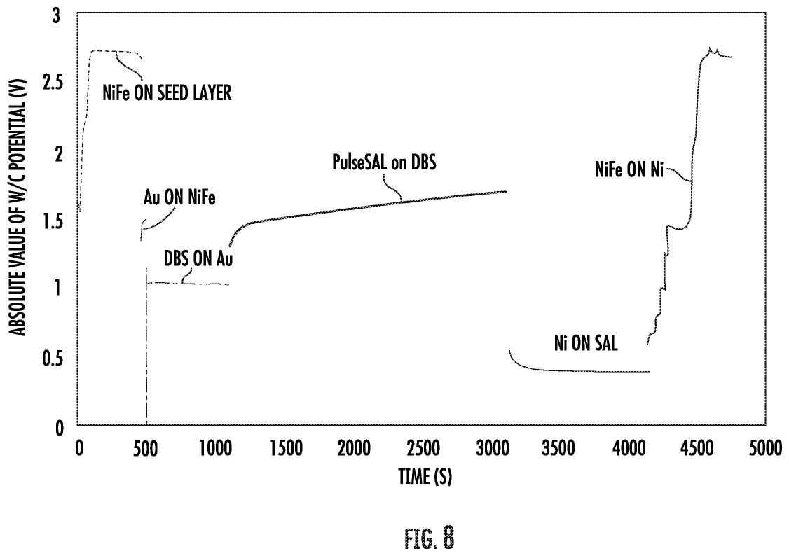

In the process described in Table 2, the cathodic NiFe deposition controls the magnetic layer thickness, a thin gold layer is deposited on top of the NiFe to prevent corrosion during subsequent polymer deposition, a thick PPyDBS film is electropolymerized for insulation and good □ characteristics, a thin PPySal layer is pulse electropolymerized for introduction of the activation surface, and a Ni strike layer is cathodically plated for activation of the PPySal surface for the next magnetic layer deposition. A sample deposition profile is shown in FIG. 8.

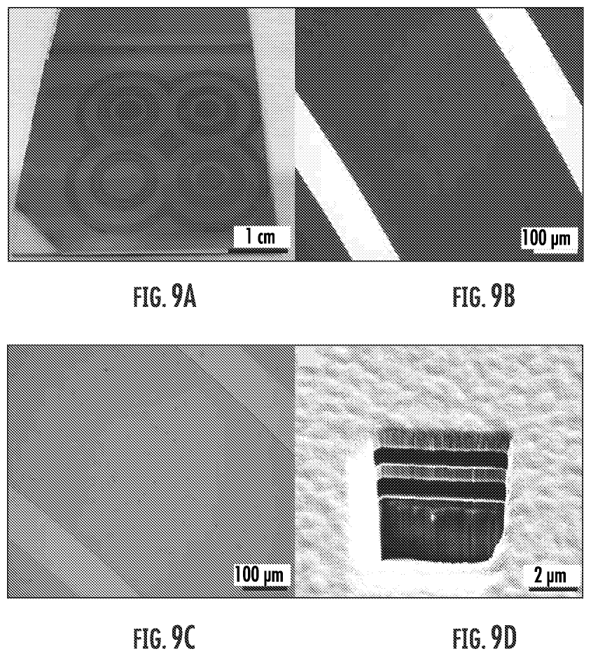

As seen in FIG. 8, the deposition profiles are very similar to the single layer experiments, except in the case of the pulse deposition of PPySal, where a 1:100 duty cycle was used. It is important to note that the Ni activation on the pulse deposited PPySal layer occurs quickly and at low potential, and that after a ramp-up of current density the second NiFe magnetic layer deposition occurs at the same potential as the initial layer coated on top of the sputtered seed metal. This indicates that a robust process has been established, which is further validated by the optical and SEM images shown in FIGS. 9A-9D.

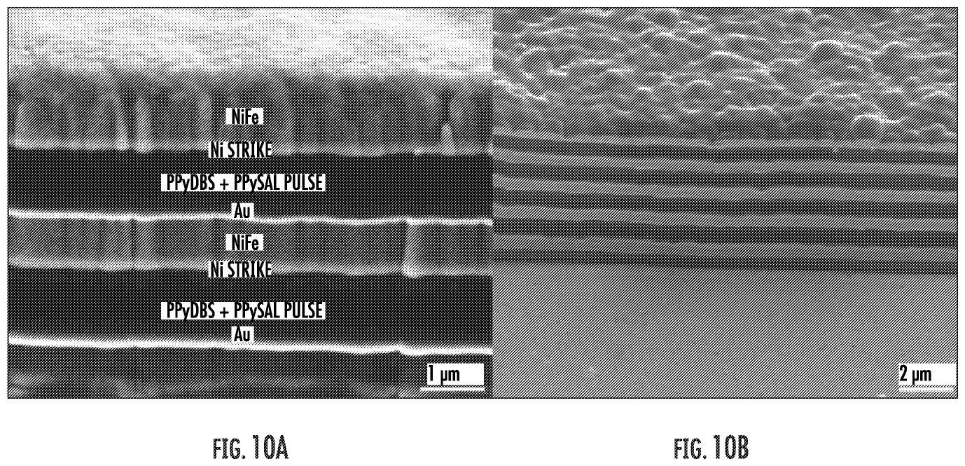

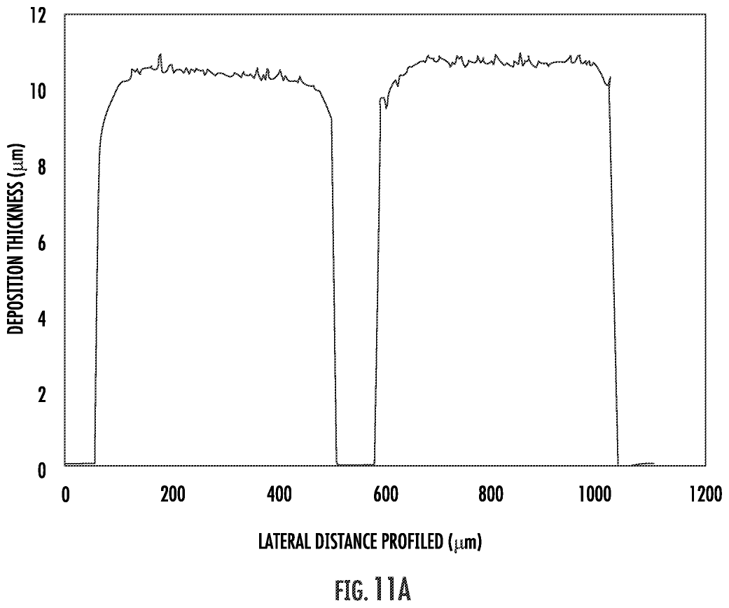

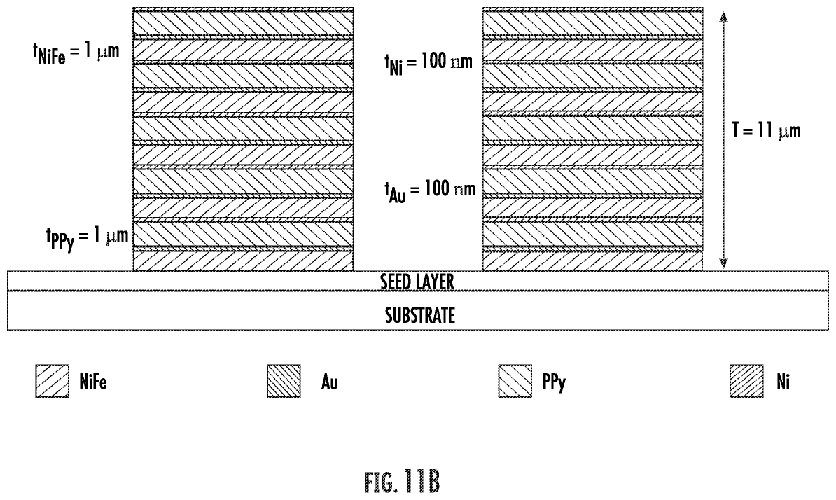

FIG. 9A shows the actual plated toroidal sample after multiple sets of the five-bath process have been completed, with the top layer of NiFe showing. The image demonstrates excellent plating uniformity across the patterned area of the mold, and no delamination after photoresist removal. FIG. 9B shows an optical microscope image of the multi-anion PPy insulation layer after both DBS and Sal electropolymerization. The image shows a smooth surface as well as no visible growth at the edges of the pattern. FIG. 9C shows the top NiFe surface on the same pattern after multiple five-bath sets have been completed. Again, the plated layers are smooth and show no indication of lateral growth impact. Lastly, in FIG. 9D, a FIB/SEM cross sectional image is shown, highlighting the smooth and distinct PPy and NiFe laminations after multilayer electrodeposition. In FIG. 10A, a magnified version of FIG. 9D is provided, where each of the five layers in the set are identified.

As seen in the magnified cross-section, the ˜100 nm thick gold protection layer prevents damage to the NiFe active layer during PPy electropolymerization, and a uniform Ni strike activation layer is achieved on the multi-anion PPy insulation set, resulting in multiple successful NiFe plated layers. After all layers in the set were deposited, sample thicknesses were measured in the profilometer to determine a. It was found that for the individual PPy layer αₐᵥₑ=1.2+/−0.08, and for the overall sets αₐᵥₑ=1.15+/−0.14. This is evident in FIG. 10B, which shows the absence of excess layer thickness in a cross section at the sidewall, where the photoresist mold was removed. A sample profilometry scan of a five-set multilayer lamination is provided in FIG. 11A, in which the lack of peaks at the edge of the pattern walls (as compared to FIG. 4B, inset a)) demonstrates the suppression of polymer lateral growth during electropolymerization in all layer sets.

FIG. 11B shows a schematic of the measured patterned multilayer structure. The total metal and polymer layer thicknesses were optimized (via deposition conditions) to be one micron each, resulting in an approximately 11-micron total laminated structure. Note that peaks that would indicate lateral polymer growth during deposition are absent in the profilometry data.

These results indicate that using a combination of PPyDBS and PPySal layers was successful in both enabling multilayer structure scaling while maintaining excellent performance. The combination of these characteristics will enable the manufacture of multilayer metal/polymer composites with scalable volume while maintaining beneficial structural properties due to micro-scale layer thicknesses and material anisotropies.

### Conclusions

A five-bath sequential multilayer deposition fabrication technique was developed to optimize the fabrication of polypyrrole/permalloy composite materials. In particular, the use of sidewall-controlled electropolymerization of polypyrrole via multi-step and multi-anion deposition solutions enables structures with scalable overall volumes and simultaneously tunable (and lithographically patterned) geometries. This additive, aqueous based fabrication technology could advance the commercialization capabilities of electrodeposited conductive polymer composites, and further provides a manufacturable route to materials with anisotropic mechanical and/or electrical properties that provide utility in MEMS sensing, energy, and/or biomedical applications.

### REFERENCES

Each of the following references is hereby incorporated by reference in its entirety.
1. Fan, L. Z., & Maier, J. (2006). High-performance polypyrrole electrode materials for redox supercapacitors. Electrochemistry communications, 8(6), 937-940.
2. Huang, Y., Li, H., Wang, Z., Zhu, M., Pei, Z., Xue, Q., . . . & Zhi, C. (2016). Nanostructured polypyrrole as a flexible electrode material of supercapacitor. Nano Energy, 22, 422-438.
3. Eftekhari, A., Li, L., & Yang, Y. (2017). Polyaniline supercapacitors. Journal of Power Sources, 347, 86-107.
4. Min, H. S., Park, B. Y., Taherabadi, L., Wang, C., Yeh, Y., Zaouk, R., . . . & Dunn, B. (2008). Fabrication and properties of a carbon/polypyrrole three-dimensional microbattery. Journal of Power Sources, 178(2), 795-800.
5. Collins, G. E., & Buckley, L. J. (1996). Conductive polymer-coated fabrics for chemical sensing. Synthetic Metals, 78(2), 93-101.
6. Liu, H., Li, Q., Zhang, S., Yin, R., Liu, X., He, Y., . . . & Shen, C. (2018). Electrically conductive polymer composites for smart flexible strain sensors: a critical review. Journal of Materials Chemistry C, 6(45), 12121-12141.
7. Herrmann, S., Ritchie, C., & Streb, C. (2015). Polyoxometalate-conductive polymer composites for energy conversion, energy storage and nanostructured sensors. Dalton Transactions, 44(16), 7092-7104.
8. Okuzaki, H., Takagi, S., Hishiki, F., & Tanigawa, R. (2014). Ionic liquid/polyurethane/PEDOT:PSS composites for electro-active polymer actuators. Sensors and Actuators, B: Chemical, 194, 59-63.
9. Shklovsky, J., Reuveny, A., Sverdlov, Y., Krylov, S., & Shacham-Diamand, Y. (2018). Towards fully polymeric electroactive micro actuators with conductive polymer electrodes. Microelectronic Engineering, 199(June), 58-62.
10. Ren, K., Liu, S., Lin, M., Wang, Y., & Zhang, Q. M. (2008). A compact electroactive polymer actuator suitable for refreshable Braille display. Sensors and Actuators, A: Physical, 143(2), 335-342.
11. Kim, D. H., Wiler, J. A., Anderson, D. J. Kipke, D. R., & Martin, D. C. (2010). Conducting polymers on hydrogel-coated neural electrode provide sensitive neural recordings in auditory cortex. Acta biomaterialia, 6(1), 57-62.
12. Nambiar, S., & Yeow, J. T. (2011). Conductive polymer-based sensors for biomedical applications. Biosensors and Bioelectronics, 26(5), 1825-1832.
13. George, P. M., Lyckman, A. W., LaVan, D. A., Hegde, A., Leung, Y., Avasare, R., . . . & Sur, M. (2005). Fabrication and biocompatibility of polypyrrole implants suitable for neural prosthetics. Biomaterials, 26(17), 3511-3519.
14. Resta, I. M., Horwitz, G., Elizalde, M. L. M., Jorge, G. A., Molina, F. V., & Antonel, P. S. (2013). Magnetic and conducting properties of composites of conducting polymers and ferrite nanoparticles. IEEE transactions on magnetics, 49(8), 4598-4601.
15. Gu, H., Guo, J., Wei, H., Zhang, X., Zhu, J., Shao, L., Huang, Y., Haldolaarachchige, N., Young, D. P., Wei, S., & Guo, Z. (2014). Magnetoresistive conductive polymer-tungsten trioxide nanocomposites with ultrahigh sensitivity at low magnetic field. Polymer, 55(3), 944-950.
16. Shalygina, E. E., Kharlamova, A. M., Makarov, A. V., Vorobieva, N. V., & Lachinov, A. N. (2018). Peculiarities of the magnetic properties of thin-film three-layer Fe/Poly (diphenylene phthalide)/Fe systems. Journal of Magnetism and Magnetic Materials, 459, 328-330.
17. Synodis, M. (2019). Utilization of MEMS Techniques for the Fabrication of Scalable Energy Storage Devices (Doctoral Dissertation). Available from ProQuest Dissertations and Theses Global Database, No. 22622313.
18. Yao, D., et al., Microfabricated V-groove power inductors using multilayer Co—Zr—O thin films for very-high-frequency DC-DC converters. IEEE Transactions on Power Electronics, 2013. 28(9): p. 4384-4394.
19. Sadki, S., Schottland, P., Brodie, N. & Sabouraud, G. (2000). The mechanisms of pyrrole electropolymerization. Chemical Society Reviews, 29(5), 283-293.
20. Ansari, R. (2006). Polypyrrole conducting electroactive polymers: synthesis and stability studies. Journal of Chemistry, 3(4), 186-201.
21. Ruangchuay, L., Sirivat, A., & Schwank, J. (2004). Electrical conductivity response of polypyrrole to acetone vapor: effect of dopant anions and interaction mechanisms. Synthetic Metals, 140(1), 15-21.
22. Qi, K., Qiu, Y., Chen, Z., & Guo, X. (2012). Corrosion of conductive polypyrrole: Effects of environmental factors, electrochemical stimulation, and doping anions. Corrosion Science, 60, 50-58.
23. Bazzaoui, M., Martins, J. I., Costa, S. C., Bazzaoui, E. A., Reis, T. C., & Martins, L. (2006). Sweet aqueous solution for electrochemical synthesis of polypyrrole: Part 1-A. On non-ferrous metals. Electrochimica acta, 51(12), 2417-2426.
24. Fenelon, A. M., & Breslin, C. B. (2002). The electrochemical synthesis of polypyrrole at a copper electrode: corrosion protection properties. Electrochimica Acta, 47(28), 4467-4476.
25. Prissanaroon, W., Brack, N., Pigram, P. J., & Liesegang, J. (2004). Electropolymerisation of pyrrole on copper in aqueous media. Synthetic metals, 142(1-3), 25-34.
26. Bazzaoui, M., Martins, J. I., Bazzaoui, E. A., Reis, T. C., & Martins, L. (2004). Pyrrole electropolymerization on copper and brass in a single-step process from aqueous solution. Journal of applied electrochemistry, 34(8), 815-822.
27. Naoi, K., Oura, Y., Maeda, M., & Nakamura, S. (1995). Electrochemistry of surfactant-doped polypyrrole film (I): formation of columnar structure by electropolymerization. Journal of The Electrochemical Society, 142(2), 417-422.
28. Petitjean, J., Aeiyach, S., Lacroix, J. C., & Lacaze, P. C. (1999). Ultra-fast electropolymerization of pyrrole in aqueous media on oxidizable metals in a one-step process. Journal of Electroanalytical Chemistry, 478(1-2), 92-100.

What is claimed is:

1. A method for fabricating a multilayer metal/polymer microstructure using sequential multilayer electrodeposition, the method comprising:
depositing an active metal layer;
depositing a protective layer of a protective metal over the active metal layer;
depositing a morphological polymer layer over the protective layer;
depositing an interfacial polymer layer over the morphological polymer layer; and
depositing an activation layer of an activation metal over the interfacial polymer layer.

2. The method of claim 1, comprising forming the multilayer structure by repeatedly depositing, over a deposited activation layer, an additional active metal layer, an additional protective layer over the additional active metal layer, an additional morphological polymer layer over the additional protective layer, an additional interfacial polymer layer over the additional morphological polymer layer, and an additional activation layer over the additional interfacial polymer layer.

3. The method of claim 1, wherein the active metal layer comprises NiFe.

4. The method of claim 1, wherein the protective metal comprises an inert metal.

5. The method of claim 4, wherein the protective metal comprises Au or Pt.

6. The method of claim 1, wherein the morphological polymer layer comprises a conductive polymer.

7. The method of claim 6, wherein the morphological polymer layer comprises polypyrrole dodecylbenzensulfonate (PPyDBS).

8. The method of claim 1, wherein the interfacial polymer layer comprises a conductive polymer.

9. The method of claim 8, wherein the interfacial polymer layer comprises polypyrrole salicylate (PPySAL).

10. The method of claim 1, wherein the activation layer comprises Ni.

11. The method of claim 1, wherein the morphological polymer layer has a thickness greater than a thickness of the interfacial polymer layer.

12. The method of claim 1, wherein the active layer has a thickness greater than a thickness of the protective layer.

13. The method of claim 1, comprising fabricating an inductor using a coil and the multilayer microstructure.

14. The method of claim 1, comprising fabricating a switched-mode power converter using the multilayer microstructure.

15. The method of claim 1, comprising fabricating one of the following devices using the multilayer microstructure: bio compatible or bio-interfacing electrodes, chemical sensors, supercapacitors, and batteries.

16. A method for fabricating a multilayer microstructure using sequential multilayer deposition, the method comprising:
depositing an active layer of an active metal;
depositing a protective layer of a protective metal over the active layer;
depositing one or more layers of conductive polymer over the protective layer; and
depositing an activation layer of an activation metal over the one or more layers of conductive polymer.
